(19) United States
(12) Patent Application Publication
(10) Pub. No.: US 2004/0050593 A1
(43) Pub. Date: Mar. 18, 2004

(54) Weighing system which is appropriate for verification and method for determining measuring value data which must be appropriate for verification

(75) Inventors: Helmut Baeumel, Muehltal (DE); Reiner Schrod, Gross-Gerau (DE)

Correspondence Address: FASSE PATENT ATTORNEYS, P.A., P.O. BOX 726, HAMPDEN, ME, 04444-0726, US

(73) Assignee: Hotting Baldwin Messtechnik GMBH, Darmstadt (DE)

(21) Appl. No.: 10/362,276

(22) PCT Filed: Aug. 17, 2001
(86) PCT No.: PCT/EP01/09527

(30) Foreign Application Priority Data
Aug. 23, 2000 (DE) 100 41 251.3

(51) Int. Cl. G01G 23/01

(52) U.S. Cl. 177/25.13; 73/1.13; 73/1.15; 702/101; 177/50

(57) ABSTRACT

The invention comprises a balance (1) with at least one digital weighing cell (2, 3, 4, 5) and an evaluation unit connected to the balance. The digital weighing cell (2, 3, 4, 5) is provided with memory elements (12, 13, 14, 15) in which the weighing cell parameters and the system parameters of the balance (1) or code numbers formed thereof are stored in an unmanipulatable manner by known methods such as audit trail counters, for example. The evaluation device is embodied as a program controlled data processing device (7) and is directly connected to the balance (1) or weighing cells (2, 3, 4, 5) provided therein. The measured data of the digital weighing cells (2, 3, 4, 5) which are calibratable and/or not calibratable are read out by the program-controlled data processing device (7) during each weighing process (7), in addition to the stored weighing cell parameters and system parameters of the balance (1) or the codes formed thereof. These data are compared with the system parameters or codes formed thereof which were fed into the program-controlled data processing device (7). If a deviation is ascertained, the weighing process is terminated or at least the measuring data which are calibratable are displayed with the ascertained deviation, documented, signaled and/or recorded.

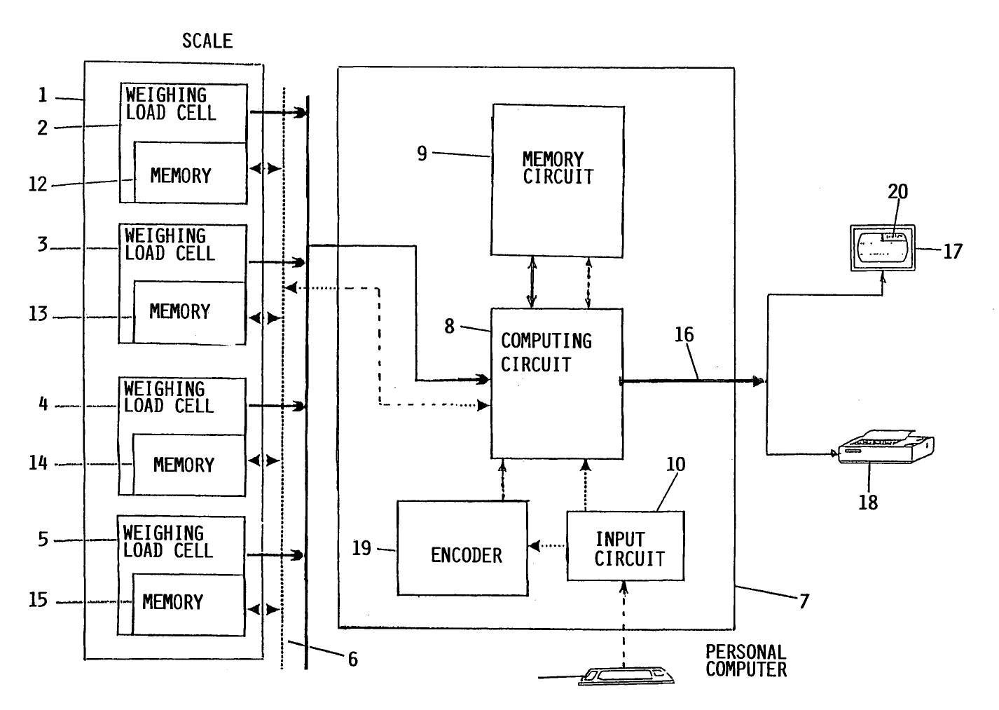

The invention relates to a calibratable weighing system according to the preamble of claim 1 and to a method for ascertaining measured value data subject to official calibration according to the preamble of Patent claim 8.

The ascertaining and processing of predominantly analog signals from a weighing cell is today almost exclusively performed in an amplifier, an A/D-converter and a microprocessing system. If the weighing cell signal is available in digital form, it can for example be directly processed through an input/output port by a microprocessor system. In this connection the microprocessor not only takes over the conversion into measuring units, the correction of influencing values and the checking of the correct functional sequence of the entire balance, rather it also performs tasks that are not balance specific such as ascertaining the piece count, guiding the operator, turn over statistics and so forth. Microprocessors available today process the counting result, for example from the A/D-converter, into the measured value while taking into account of the zero point, the tare value, the preselected maximum load range, the limit values and so forth. When balances are used in activities that are subject to official calibration the microprocessor assures without any special effort and expense the metrological safety required in several countries by checking the correct function of internal and external structural components with the aim to prevent the output of non-recognized, error containing measured values.

A calibratable weighing system is known from the “Handbook of Weighing” (Kochsiek), 2^{nd} Edition, Braunschweig/Wiesbaden, 1989, pages 567 and 568. The known system comprises an analog scale which is permanently connected to a digital evaluating unit. A program controlled data processing unit in the form of a personal computer with a monitor and a printer is releasably connected to the digital evaluating unit for further processing of the weighing data. Thereby the evaluating unit comprises an amplifier circuit, an analog-to-digital converter, a microprocessor circuit, to which are permanently connected a calibratable intermediate memory, a weight display, and an interface circuit. Since this evaluating unit (scale indicator) which is controlled by the microprocessor, cannot be controlled by the program controlled data processing unit, it is assured, that the weighing data which are subject to official calibration and which are stored in the intermediate memory are not manipulatable or that all external interventions and variations are recognized with each calibration operation. This calibratable weighing system has the disadvantage that in any case an additional microprocessor controlled calibratable scale indicator must be available between the personal computer, wherein the measured values which are subject to official calibration are documented and/or recorded.

German Patent Publication DE 195 09 775 A1 discloses a calibratable weighing system which is provided with a special calibratable weighing data processing unit. Several measured value data ascertaining devices are connectable to this calibratable data processing unit. The calibratable weighing data processing unit comprises at least a calculator with a memory unit, an operating unit and an image screen, whereby the calculator comprises, among other things, two serial interfaces for two special drives and a special memory circuit. The memory circuit comprises non-volatile stores in the form of a specifically developed EEPROM-card in which the calibratable data are intermediately stored and to which access from the operating system level of the personal computer is obviously excluded. Since this personal computer is constructed as a weighing data processing unit possessing special non-manipulatable memory elements and special drivers, it is necessary that this program controlled data processing unit is equipped with special memory elements and which, if used in an operation that is subject to official calibration, requires a separate permit from the Bureau of Standards.

Thus, it is the object of the invention to provide a calibratable weighing system in which conventional programmed controlled data processing units can be used for the processing of weighing data that are subject to official calibration and that are not subject to official calibration.

This object has been achieved by the invention as defined in Patent claim 1 and Patent claim 8. Further developments and advantageous example embodiments of the invention are defined in the dependent claims.

The invention has the advantage that due to the storing of system relevant parameters of the balance or storing of encodings formed of these parameters in the memory elements of the digital weighing cell, measured value data that are subject to official calibration are possible with conventional personal computers without interposing calibrated evaluation devices. Thereby, the personal computer can be connected with the balance or with the individual digital weighing cells in a disconnectable manner, for example through plug-in connections without thereby affecting the calibration capability. Due to this, it is advantageously possible to exchange the personal computer at any time as an evaluation unit or it can be connected to other balances subject to official calibration without the need that it must be subject to a calibration technical examination.

The invention has the further advantage that due to the subsequent possibility of downloading the system parameters of the scale in a conventional personal computer or any other weighing data processing unit the most diverse balances that are subject to official calibration, are connectable. Thus, additional balances subject to official calibration are also connectable to this type of weighing data processing unit at any time. This can be done without any official calibration permit of the weighing data processing unit that is being used or for the personal computer that is being used.

Since the calibratable weighing system can be operated with almost any program controlled data processing unit, it becomes possible that each balance subject to official calibration can be advantageously connected to personal computers or weighing data processing units that are already available or can be connected to other program controlled data processing units.

The invention has the further advantage that the calibration procedure of a weighing system that is subject to official calibration is substantially reduced because only the balance is subject to official calibration to obtain the calibration technical permit without the need for an official calibration of the evaluation units or the data processing units by the Bureau of Standards for the purpose of issuing a permit.

The invention will be described in more detail with reference to an example embodiment that is shown in the drawing which illustrates schematically a calibratable digital weighing system.

The calibratable digital system comprises substantially a balance 1 having installed therein digital weighing cells 2, 3, 4, 5 with electronic memory elements 12, 13, 14 and 15 and a program controlled data processing unit 7.

The digital weighing cells 2, 3, 4, 5 are, for example, conventional analog bending ring weighing load cells or bending beam weighing load cells which are connected with analog-to-digital converter circuits, counter-circuits and memory elements 12, 13, 14 and 15. The weighing cells 2, 3, 4, 5 can be installed in different types of balances such as vehicle scales or platform scales. The cells then supply converted digital signals which are proportional to the weight loading of the respective weighing cells 2, 3, 4 and 5. The relevant weighing cell parameters are stored in the memory elements 12, 13, 14 and 15 which determine the interrelation between the weighing cell loading and the delivered output signals. These weighing cell parameters are ascertained, for example, during a loading procedure with different known loads under different loading conditions and stored in the memory elements 12, 13, 14 and 15. These weighing cell parameters include, among others, parameters which, for example, describe a weighing cell recognition, the temperature characteristic, the weighing cell sensitivity and the load range.

Since the digital weighing cells 2, 3, 4, 5 are provided for a calibratable weighing system, it is necessary that the memory elements 12, 13, 14 and 15 thereof are safe against manipulation. Thus, it is possible to provide memory elements that cannot be changed. However, variable memory elements in the form of over-writable EEPROM-memories are permissible which, however, are provided with counters that cannot be manipulated. The counters indicate for each change a so-called “audit-trail-number”. This number is marked down visibly, during each calibrating procedure, on the weighing cell or on the balance and must be displayed and recorded at each weighing procedure. The described digital weighing cells 2, 3, 4 and 5 comprise over-writable semiconductor memory elements in the form of an EEPROM with non-manipulatable counter circuits which increase the so-called audit-trail-number by one and which signal that number in an interrogatable manner.

The illustrated weighing system shows a balance 1 such as a vehicle scale, which comprises four digital weighing cells 2, 3, 4 and 5 for ascertaining the weight. The vehicle scale 1 is connected through a conventional bus system 6 with a weighing data processing unit 7 which comprises computer circuits and memory circuits 8, 9, 10 and 19. A calibrated vehicle weight or the load weight thereof is ascertainable from the digital weighing cell data with the aid of the weighing data processing unit. This weighing data processing unit is constructed as a conventional data processing unit 7 which comprises program-controlled conventional computer and memory circuits 8, 9 and an input circuit 10 for inputting and intermediate storing of weighing system parameters and an encoding circuit 19 for encoding the system parameters. The data processing unit can also be formed by a conventional program controlled personal computer 7 which ascertains from the transmitted and stored calibratable scale and weighing cell data calibratable weight values which are shown in the drawing as continuous connection lines. For this purpose it is necessary to enter or ascertain in the data processing unit or rather in the personal computer 7 additional system parameters of the connected scale 1. The system parameters must be available in a read-out manner for the ascertaining of the weight. Therefore, these system parameters are stored in a memory circuit 9 or in a hard disk memory. The memory circuit 9 can be over-written at any time and even in a calibrated weighing system the calibration measure need not be specially secured in the data processing unit 7.

In connection with the given and stored system parameters it is necessary that, for example the type of balance 1, such as a vehicle balance or platform balance with its rated load and the number of weighing cells are available for read-out through an input circuit 10 of the computer circuit 8. For example the zero point characteristic, the stability criteria, the minimal and maximal load values, as well as balance characteristic factors are also inputted or ascertained as system parameters of a balance 1. The predetermined system parameters can be entered through an input keyboard 11 or through other input devices of the input circuit 10. These system parameters are available for the computer circuit and the memory circuit 8 for the weight ascertaining, whereby these parameters can be read-out from the input circuit 10 and/or from the memory 9.

However, the balance characteristic is ascertained when the balance is taken into service or during a calibrating procedure with the help of predetermined reference loads and the balance characteristic is stored in the input circuit 10 and/or in the memory circuit 9 for read-out. For achieving the calibratability, these system parameters, however, can also be simultaneously stored in the memory elements 12, 13, 14, 15 of the load cell 2, 3, 4, 5. As part of the storing of the system parameters in the circuits 12, 13, 14 and 15 of the digital weighing cells 2, 3, 4, 5, the so-called audit-trail-number is thereby simultaneously stepped up by one so that any variation is documented in a repeatable manner. For calibrating the balance 1 now only the audit-trail-number is attached to the balance 1 as part of the calibration procedure so that any subsequent change of the weighing cells or system parameters is ascertainable.

During each subsequent weighing procedure the weighing cell parameters and the digital load values are now interrogated by the computer and memory circuit 8 and there put into intermediate storage. Simultaneously the system parameters of the balance 1 are read-out by the computer and memory circuit 8 and compared with the system parameters stored in the input circuit 10 or in the memory circuit 9. Any deviation is ascertained and signaled. If a deviation occurs, it may now be provided that the weighing procedure is terminated or the weighing result is indicated or recorded. If, on the other hand, no deviation between the system parameters stored in the weighing cells 2, 3, 4, 5 and the used system parameters was ascertainable, the ascertaining of the weight can be continued by the computer and memory circuit 8.

In connection with a calibratable or calibrated balance 1 the vehicle weight is now calculated by addition on the basis of the interrogated load signals while taking into account the tare weight and other system parameters as, for example the number of times the maximum load has been exceeded and/or pre-determined stability criteria. This weight value is then available for read-out at the output 16 of the computer and memory circuit 8. The weight value may, for example, be indicated by a display or a monitor and/or it may be recorded by a printer.

In a calibratable weighing device 1 the computer and memory circuit 8 is also so constructed that it always indicates and records, in connection with over-writable weighing cell memories 12, 13, 14 and 15, also the audit-trail-number so that any manipulation on the scale or on the weighing cells 2, 3, 4 and 5 is reconstructable and recognizable.

In an advantageous embodiment of the weighing system it is possible to save storage space in the weighing cell memory elements 12, 13, 14 and 15 by doing without the complete storing of the system parameters. For this purpose an encoding circuit 19 is provided in the data processing unit 7. The encoding circuit 19 forms from the system parameters, for example a CRC-code. This formed code number could then be stored in addition to the weighing cell parameters in the weighing cell memory elements 12, 13, 14 and 15, the connections of which are shown in the drawing by the dotted lines. In that case, in each weighing procedure the CRC-code would also be formed of the relevant system parameters. This CRC-code would be compared with the code numbers stored in and read-out from the weighing cell memories 12, 13, 14 and 15. If there is coincidence, it would be assured that the system parameters have not been changed since the storing or calibrating.

Advantageously in such a calibratable digital weighing system the data processing unit 7 can be exchanged at any time without the need for a new calibration of the weighing system. Thus it would be necessary to merely enter the previous system parameters again into the new data processing unit 7. Such entry would not lead to a variation in the parameters or in the code number formed thereof in the weighing cells 2, 3, 4 and 5. As a result, no deviation would be recognizable. A conventional personal computer would be connectable at any time to such a digital balance 1. The computer and memory units of the personal computer would merely have to perform the predetermined program controlled signal processing steps by means of which the described circuits 8, 9, 10 and 19 of the weighing data processing unit would ascertain the weighing result and other measured value data. Advantageously, such signal processing steps of the digital weighing signals by a storable processing program are predeterminable and can therefore be performed by any conventional personal computer or data processing device.

1. A calibratable weighing system comprising a balance (1) with at least one digital weighing cell (2, 3, 4, 5) and an evaluation unit connected thereto, wherein the digital weighing cell (2, 3, 4, 5) is connected with memory elements (12, 13, 14, 15) in which parameters of the cell are stored, and wherein the evaluation unit ascertains calibratable and/or non-calibratable measured value data from the load values of the weighing cells, from the weighing cell parameters and from the system parameters of the balance (1), characterized in that the system parameters of the balance (1) or encodings formed of the system parameters of the balance (1) are additionally stored in the weighing cell memory elements (12, 13, 14, 15) in a non-manipulatable manner, that the evaluation unit is constructed as a program controlled data processing unit (7), which compares in each weighing procedure the relevant system parameters or the encodings formed out of the relevant system parameters with the system parameters stored in the weighing cells or with the encodings formed thereof, and wherein said data processing unit interrupts the weighing procedure in response to an ascertained deviation or at least records, signalizes, or displays the deviation in a verifiable manner with the calibratable measured value data.

2. The calibratable weighing system of claim 1, characterized in that the digital weighing cells (2, 3, 4, 5) are made as bending beam, bending ring, pendulum rod or a comparable weighing cell construction, which is connected to an electronic modular unit, comprising in addition to an analog-to-digital converter, memory elements (12, 13, 14, 15), wherein the weighing cell parameters and the relevant system parameters of the balance (1) or an encoding formed thereof are stored in an unmanipulatable manner.

3. The calibratable weighing system of claim 1 or 2, characterized in that the memory elements (12, 13, 14, 15) are so constructed that they store in addition to the weighing cell parameters and the system parameters of the balance (1) or the encodings formed thereof, modifying number steps (audit-trail-number) in an unmanipulatable manner, which keep counting one unit for each memory modification, and that the memory is readable only with the counter step values (audit-trail-number) whereby the data processing unit (7) also compares in each weighing procedure the read-out audit-trail-number with the audit-trail-number stored in the data processing unit (7), and, if a deviation is ascertained, stops the weighing procedure or at least records, signalizes or displays the deviation with the calibratable measured value data.

4. The calibratable weighing system of one of the preceding claims, characterized in that the memory elements (12, 13, 14, 15) of the digital weighing cell (2, 3, 4, 5) with the system parameters of the balance (1) or the encodings formed thereof can be read-out or can be read-out and described by the program controlled data processing unit (7).

5. The calibratable weighing system of one of the preceding claims, characterized in that the program controlled data processing unit (7) is constructed as a conventional personal computer, or as a special program controlled weighing data processing unit, or as a mainframe computer which is permanently or releasably directly connected with one or several balances (1) or with the digital weighing cells (2, 3, 4, 5) provided therein.

6. The calibratable weighing system of one of the preceding claims, characterized in that the program controlled data processing unit (7) comprises at least a computer and memory circuit (8), a memory (9), input-(10) and output-(16) circuits by means of which at least the measured value data, the weighing cell parameters and the system parameters of the balance (1) can be read-out from the digital weighing cell or from the digital weighing cells (2, 3, 4, 5) and with the aid of which and the given computer program for the evaluation of the measured value data, the intended measured values subject to official calibration and/or the measured values not subject to official calibration, are ascertained and outputted, indicated and/or recorded in a verifiable manner.

7. The calibratable weighing system of one of the preceding claims, characterized in that the program controlled data processing unit (7) comprises a code controlled or a program controlled computing circuit (8, 19) by means of which a code number can be calculated on the basis of the inputted and/or the ascertained system parameters of the balance (1), which calculated code number serves for comparing with the code number that is stored or is to be stored in the digital weighing cell (2, 3, 4, 5) for each weighing procedure.

8. A method for ascertaining of measured value data which are and/or are not subject to official calibration by one of the officially calibratable weighing systems according to the claims 1 to 7, characterized in that the program controlled data processing unit (7) performs in each weighing procedure a read-out operation of the measured values ascertained by the digital weighing cells (2, 3, 4, 5), of the weighing cell parameters stored therein and of the system parameters of the balance (1), or of the code number formed thereof and the audit-trail-number, and further compares at least the read-out system parameters with the relevant system parameters entered in the data processing unit (7) or with the code number formed thereof and the stored audit-trail-number, said unit (7) either stopping the weighing procedure in response to a deviation or continuing the weighing procedure to indicate, signal, document and/or record the then also ascertained measured value data that are subject to official calibration and/or are not subject to official calibration.
